(19) United States
(12) Patent Application Publication
(10) Pub. No.: US 2010/0154370 A1
(43) Pub. Date: Jun. 24, 2010

(54) SYSTEM AND METHODS FOR PARTICULATE FILTER

(75) Inventors: Jeff Alan Jensen, Dunlap, IL (US); Chuong Quang Dam, Peoria, IL (US); Thomas Edward Paulson, Groveland, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc,, Peoria, IL (US)

(21) Appl. No.: 12/341,112

(22) Filed: Dec. 22, 2008

(51) Int. Cl. B01D 39/14

(52) U.S. Cl. 55/495; 29/428

(57) ABSTRACT

Various examples of system and methods for particulate filters include a particulate filter comprising a housing having a flow axis between an input header and an output header, and a plurality of filter segments arranged in a stacked array, the stacked array disposed within the housing and lying in a plane normal to the flow axis, the stacked array including a first filter segment having a first average flow characteristic per unit area and a second filter segment having a second average flow characteristic per unit area, the first average flow characteristic per unit area different from the second average flow characteristic per unit area, each particular filter segment of the plurality of filter segments having a segment flow axis substantially in parallel alignment with the flow axis.

### TECHNICAL FIELD

This invention relates generally to systems and methods for particulate filters, and in particular, to diesel particulate filters.

### BACKGROUND

Internal combustion engines generate mechanical energy by burning a mixture of fuel and a source of oxygen, the oxygen generally obtained by the intake of ambient air. In a diesel engine, the combustion process involves burning a mixture of diesel fuel and air, which results in the generation of exhaust, which includes exhaust gases and particulate matter. The particulate matter is often referred to as soot. The exhaust, including the particulate matter, are exhausted from the diesel engine through an exhaust system. A diesel particulate filter (DPF) is often employed as part of the exhaust system in order to filter all or most of the soot from the exhaust before the exhaust is released from the exhaust system.

### SUMMARY

In one example, a particulate filter is provided comprising a particulate filter comprising a housing having a flow axis between an input header and an output header, and a plurality of filter segments arranged in a stacked array, the stacked array disposed within the housing and lying in a plane normal to the flow axis, the stacked array including a first filter segment having a first average flow characteristic per unit area and a second filter segment having a second average flow characteristic per unit area, the first average flow characteristic per unit area different from the second average flow characteristic per unit area, each particular filter segment of the plurality of filter segments having a segment flow axis substantially in parallel alignment with the flow axis.

In one example, a particulate filter is provided comprising a particulate filter comprising a housing having a flow axis between an input header and an output header, and a plurality of filter segments arranged in a stacked array, the stacked array disposed within the housing and lying in a plane normal to the flow axis, including a first filter segment formed of a first material, and a second filter segment formed of a second material that is different from the first material, each particular filter segment of the plurality of filter segments having a segment flow axis substantially in parallel alignment with the flow axis and having a distribution of channels within the particular filter segment.

In one example, a method is provided comprising a method of forming a filter comprising selecting a first filter segment having an input surface operable to receive exhaust and an exit surface operable to allow filtered exhaust to exit the first filter segment, the first filter segment having a first flow capacity per unit area of the input surface, selecting a second filter segment having an input surface operable to receive exhaust and an exit surface operable to allow filtered exhaust to exit the second filter segment, the second filter segment having a second flow capacity per unit area of the input surface that is different from the first flow capacity, and arranging at least one of the first filter segments and at least one of the second filter segments in a stacked array of a plurality of filter segments to form a filter brick having input surfaces on a first side of the filter brick and exit surfaces on a second side of the filter brick.

### BRIEF DESCRIPTION OF THE DRAWINGS

FIG. 1 illustrates a cut away view of a portion of an exhaust system including a filter;

FIG. 2 illustrates an end view of a filter brick comprising a plurality of filter segments;

FIG. 3 illustrates a perspective view of a filter segment;

FIG. 4 illustrates one or more processes for forming a particulate filter; and

FIG. 5 illustrates a flowchart according to various methods.

### DETAILED DESCRIPTION

In the following detailed description, reference is made to the accompanying drawings that form a part hereof, and in which is shown, by way of illustration, specific embodiments, shown by various examples, in which the invention may be practiced. These embodiments are described in sufficient detail to enable those skilled in the art to practice the invention, and it is to be understood that the embodiments may be combined, or that other embodiments may be utilized and that structural, logical changes, along with changes in materials used, can be made without departing from the scope of the present subject matter. The following detailed description is, therefore, not to be taken in a limiting sense, and the scope of the present invention is defined by the appended claims and their equivalents.

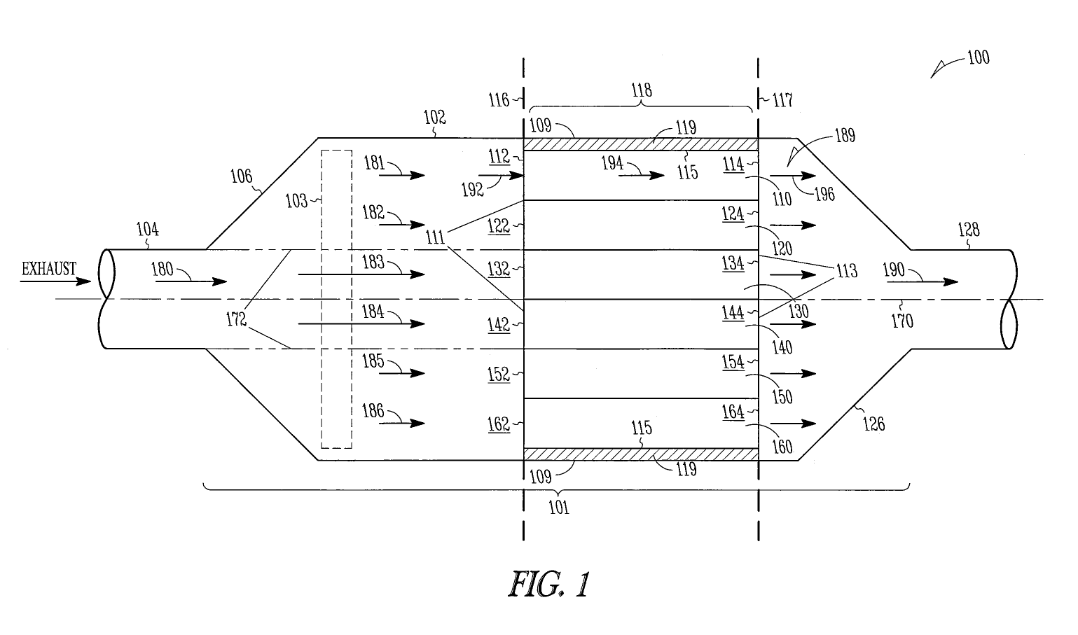

FIG. 1 illustrates a cut away view of a portion of an exhaust system 100, including filter 101. Filter 101 includes a housing 102, including an input header 106 and an exit header 126. One or more portions of housing 102 can be referred to as the filter casing, or simply the “casing.” Housing 102 is not limited to any particular material, and can be any material, for example but not limited to stainless steel or galvanized steel of any appropriate gauge or gauges for forming housing 102.

Input conduit 104 couples to input header 106 of housing 102. Exit conduit 128 couples to exit header 126 of housing 102. A filter brick 118 is included within housing 102. Filter brick 118 is located between input header 106 and exit header 126 and along a longitudinal axis 170. In some examples, longitudinal axis 170 runs approximately from the geometric center of input header 106, through filter brick 118, and through the geometric center of exit header 126. In some examples, longitudinal axis 170 is referred to as a flow axis in that when exhaust is moving through filter 101, the flow of exhaust progresses from input header 106 to filter brick 118, passing through filter brick 118 as filter brick 118 filters particulate matter from the exhaust, the exhaust then exiting filter brick 118 into exit header 126.

In some examples, filter brick 118 is a diesel particulate filter. In some examples, filter brick 118 is formed of a stacked array of filter segments 110, 120, 130, 140, 150, and 160. It would be understood that because FIG. 1 is illustrated as a cut-away view, additional filter segments, both in front of and behind filter segments 110, 120, 130, 140, 150, and 160 can be included in filter brick 118. Additional filter segments that would be included in filter brick are not illustrated in FIG. 1 for the sake of clarity in illustrating the filter brick as included in housing 102.

The plurality of filter segments, including filter segments 110, 120, 130, 140, 150, and 160, can be mechanically coupled together to form the filter brick 118, which can also be referred to as a “brick.” Filter brick 118 includes any number of filter segments. The filter segments are arranged in a stacked array and are mechanically coupled together. In some examples, a stacked array can be any arrangement of filter segments that form a 3-dimensional volume. In some examples, a stacked array includes filter segments arranged in columns and rows. In some examples, the 3-dimensional volume includes no voids or open passages through the 3-dimensional volume other than those provided within a given filter segment, as will be further described herein.

In one example, the stacked array of filter segments includes an input side 111, an output side 113, and an outside surface generally represented by reference number 115. Input side 111 is adjacent to input header 106. Output side 113 is adjacent exit header 126. Outside surface 115 is substantially adjacent to an interior surface 109 of housing 102. In some examples, after the filter segments included in filter brick 118 are mechanically coupled, the filter brick 118 is machined or otherwise processed on one or more surfaces to form the outside surface 115. Filter segments 110, 120, 130, 140, 150, and 160 are formed of various materials and in various configurations so as to allow exhaust to pass through the filter segments, and to allow certain portions of the exhaust, such as particulate matter, to be trapped in the filter segments while other portions of the exhaust pass out of the filter segments.

By way of illustration, arrow 192 represents exhaust received at filter segment 110, arrow 194 represents the exhaust flowing through and being filtered by filter segment 110, and arrow 196 represents filtered exhaust exiting filter segment 110 and entering into exit header 126. It would be understood that a flow as described for filter segment 110 can occur for each of the filter segments included in filter brick 118, wherein a segment flow axis, typically corresponding to arrow 194 but within each individual filter segment, flows through each filter segment substantially in parallel with flow axis 170.

In various examples, the outside surface 115 is surrounded by sheath 119 along some or all of the outside surface 115. In some examples, sheath 119 is a mesh. In some examples, sheath 119 conforms to the shape of outside surface 115, wherein outside surface 115 is a shape that is substantially the same shape as the interior surface 109 of housing 102. As shown in FIG. 1, sheath 119 forms a layer between outside surface 115 and interior surface 109. In some examples, sheath 119 is operable to isolate filter brick 118 from vibrations transmitted through housing 102. In some examples, sheath 119 is operable to hold filter brick 118 in place and prevent filter brick 118 from physically shifting along longitudinal axis 170 once filter brick 118 is installed in housing 102. The thickness of the sheath is not limited to any particular thickness, and in various examples has a thickness ranging for 4 to 7 millimeters.

In some examples, each of the filter segments included in filter brick 118 have an input face on a side of the filter brick 118 facing the input header 106. By way of illustration, filter segment 110 includes an input face 112, filter segment 120 includes an input face 122, filter segment 130 includes an input face 132, filter segment 140 includes an input face 142, filter segment 150 includes an input face 152, and filter segment 160 includes an input face 162. In some examples, input faces 112, 122, 132, 142, 152, and 162 are coplanar, as represented by dotted line 116. Input faces 112, 122, 132, 142, 152, and 162 are operable to receive exhaust passing through input header 106, and to allow the exhaust to enter within filter segments 110, 120, 130, 140, 150, and 160 respectively for filtering of particulate matter from the exhaust.

In some examples, filter segments 110, 120, 130, 140, 150, and 160 include exit faces 114, 124, 134, 144, 154, and 164 respectively. In some examples, exit faces 114, 124, 134, 144, 154, and 164 include faces on a side of filter brick 118 facing the exit header 126. In some examples, exit faces 114, 124, 134, 144, 154, and 164 are coplanar, as represented by dotted line 117. Exit faces 114, 124, 134, 144, 154, and 164 are operable to allow exhaust to exit the filter segment associated with the exit face, and to pass from the associated filter segment into exit header 126.

In operation, exhaust is conveyed through input conduit 104 as represented by arrow 180. Exhaust flows from input conduit 104 into input header 106. The exhaust flow in input header 106 is represented by arrows 181, 182, 183, 184, 185, and 186. As represented by arrows 181, 182, 183, 184, 185, and 186, the distribution of exhaust flow through different portions of input header 106 can be different in magnitude or in flow rate from each other at a given time. By way of illustration, exhaust flows represented by arrows 183 and 184 can be greater than the exhaust flows represented by arrows 181, 182, 185, and 186 at any given time during operation. In some examples, the difference in exhaust flows is a result of the location, the size, and the shape of input conduit 104 relative to the location, size, and shape of input header 106. As a result, the exhaust flows received at the various input faces of the filter segments at different locations of input side 111 can be different at any given time.

By way of illustration, exhaust flow can be greater in the input header 106 in the areas more in line with the input conduit 104, as represented by the area between lines 172, including arrows 183 and 184, than the exhaust flow represented by arrows 181, 182, 185, and 186. This can result in a larger volume or larger rate of exhaust flow reaching the input faces 132 and 142 of filter segments 130 and 140 as compared to the volume or rate of exhaust flow reaching, for example input faces 112, 122, 152, and 162 of filter segments 110, 120, 150, and 160 respectively.

In some examples, different exhaust flow volumes or rates within input header 106 can be caused by devices present within the input header 106. These devices can include baffles or other deflective surfaces within the interior of housing 102. By way of illustration, device 103 is a regeneration unit included in input header 106 in order to regenerate filter 101. Regeneration can include heater units in some examples, or fuel injection units in some examples, that can be used in a regeneration process. Regeneration processes are generally used to regenerate filter 101 by at least partially removing, or by reducing to some other form, some or all of the residue built up in filter brick 118. The residue is formed as a result of filtering particulate matter from the exhaust passing through filter brick 118. Device 103 in some examples can contribute to an uneven distribution of exhaust flows within input header 106.

In some examples, the distribution of exhaust flow in input header 106 is received at the input faces 112, 122, 132, 142, 152, and 162 of filter segments 110, 120, 130, 140, 150, and 160. The input faces 112, 122, 132, 142, 152, and 162 allow the received exhaust to pass into the associated filter segments in such a way that the material forming the filter segments can trap particulate matter within the filter segment. The exhaust then exits the filter segments through the associated exit faces 114, 124, 134, 144, 154, and 164, respectively as represented by arrows 189. The exhaust flow exiting from exit faces 114, 124, 134, 144, 154, and 164 enters into exit header 126. In some examples, the exhaust flow exiting from filter segments 110, 120, 130, 140, 150, and 160 is generally more uniform than the exhaust flows through input header 106. In some examples, the exhaust flow from each of filter segments 110, 120, 130, 140, 150, and 160 is substantially equal.

In some examples, the flow characteristics of one or more of filter segments 110, 120, 130, 140, 150, and 160 are different from the flow characteristics of at least one, or in some examples, a plurality of the other filter segments 110, 120, 130, 140, 150, and 160 so that the different flow characteristics compensate for the uneven exhaust flow in the input header 106. The compensation can provide a different, and generally more uniform exhaust flow through each of filter segments 110, 120, 130, 140, 150, and 160 and into the exit header 126.

This more uniform flow can result in a substantially uniform thermal loading across the filter segments including in filter brick 118. A more uniform thermal loading of filter brick 118 reduces the chance of mechanical damage, such as breaking or cracking of the filter brick 118 that can be caused by non-uniform thermal stress. A more uniform exhaust flow within the filter segments within filter brick 118 can also increase the efficiency of operation of the filter brick by extending the time period between regenerating the filter brick.

The exhaust flow entering exit header 126 exits filter 101 by being conveyed through exit conduit 128, as represented by arrow 190.

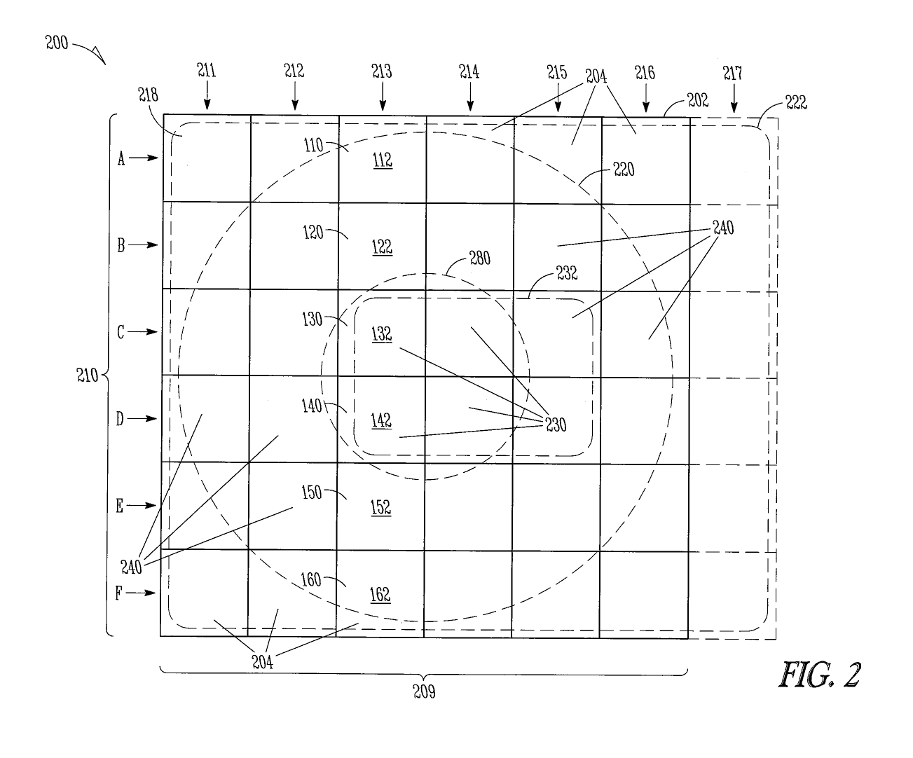

FIG. 2 illustrates an end view 200 of a filter brick 202 comprising a plurality of filter segments 204. In some examples, end view 200 is an end view of filter brick 118 as shown in FIG. 1, viewing filter brick 118 looking into input side 111. As shown in FIG. 2, filter brick 202 includes filter segments 110, 120, 130, 140, 150, and 160, having input faces 112, 122, 132, 142, 152, and 162 respectively, arranged as a stack in a column.

In some examples, filter segments 204 are arranged in a plurality of columns 209 including columns 211, 212, 213, 214, 215, and 216, and a plurality of rows 210, including rows A, B, C, D, E, and F. For purposes of the discussion included herein with respect to FIG. 2, a given filter segment as shown in FIG. 2 can be referred to by the column number and the row letter in which the filter segment is associated. By way of illustration, the filter segment in the upper-most left hand position in filter brick 202, indicated by reference number 218, can also be identified as filter segment 211A, representing the filter segment that is in both column 211 and in row A.

The number of rows and the number of columns in filter brick 202 are not limited to any particular numbers. In various examples, the number of rows, the number of columns, or both the number of rows and the number of columns is different from those as shown in FIG. 2. In some examples, the number of rows can be more than the number of columns, or the number of columns can be more than the number of rows. In some examples, one or more of filter segments 204 extend into more than one row, or more than one column, or both. By way of example, a filter segment having a rectangular shaped side when viewed as shown in FIG. 2 could extend horizontally to include two columns, or could extend vertically to include two rows.

It would be understood that the shape and the dimensions of the sides of the filter segments 204 as shown in FIG. 2 are illustrative, and any other arrangements of different sizes and shapes of filter segments can be included in forming a filter brick. In some examples, the filter segments could have triangular shapes arranged in an interlocking arrangement. In some examples, filter segments 204 could have a round shape, the filter segments arranged in stacked columns and rows, or in radially arranged rays extending out from a central point, with a filler or a cement used to seal the areas between the filter segments.

In some examples, filter segments 204 include one or more filter segments that have different dimensions or different shapes than other filter segments of a particular brick. For example, some of filter segments 204 can have a square shape as shown in FIG. 2, while other filter segments in filter brick 202 can have a rectangular shape. In some examples, some of the filter segments are of a given dimension, but have different orientations from other filter segments having the same dimensions. For example, filter segments all having the same rectangular dimensions when viewed as shown in FIG. 2 could have the longer dimension of some of the filter segments oriented in a different direction, for example, either vertically or horizontally, with respect to the direction of orientation of the longer dimension of other filter segments within filter brick 202.

The number of rows and the number of columns included in filter brick 202 is generally determined in order to construct a filter brick 202 that has a cross-sectional area larger in every dimension than the area enclosed within dashed line 220. Dashed line 220 represents the shape, compensated for the addition of a sheath (such as sheath 119 as shown in FIG. 1) that filter brick 202 would be cut to in order to provide filter brick 202 with a overall shape and dimensions along the length of filter brick 202. The overall shape and dimensions, along with a sheath if included, provides a cross-sectional area for filter brick 202 that substantially conforms to an interior wall surface of an enclosure, such as a housing or casing, into which the filter brick 202 is to be installed. As part of the processing of filter brick 202 based on dashed line 220, all of filter segments 211A, 211F, 216A, and 216F would be removed from filter brick 202. In addition, portions of filter segments in columns 211 and 216 and in rows A and F that are outside dashed line 220 will also be removed along a length of filter brick 202. The length includes the dimension extending beyond (behind) the side of filter brick 202 shown in FIG. 2.

In some examples, after processing filter brick 202 will have a substantially cylindrical shape having length along the longitudinal axis of the filter brick, and having an input face including the filter segments and the portions of the filter segments that are included within dashed line 220.

In some examples, the plurality of filter segments 204 include at least one filter segment having a first average flow characteristic per unit area, and at least one filter segment having a second average flow characteristic per unit area that is different from the first average flow characteristic. An average flow characteristic per unit area is a unit of measure that describes the capacity of a filter segment to allow a flow of exhaust through the filter segment per a unit area of the filter segment. In some examples, the unit area is the square area of surface of the input face of the filter segment. In some examples, the average flow characteristic per unit area would be determined using a standard set of conditions, such as a clean (that is, unused) filter segment with exhaust having some known pressure and a known rate of flow applied to the input face of the filter segment.

The number and the arrangement of the filter segments having these different flow characteristics within the filter brick 202 can be selected to achieve a certain flow pattern of exhaust at the exit side of filter brick 202 in view of a given pattern of exhaust flow to be provided at the input face of filter brick 202. In some examples, a substantially uniform flow of exhaust is provided at the exit side of filter brick 202 despite an uneven distribution of exhaust flow arriving at the input side of filter brick 202 by the arrangement of the filter segments having different flow characteristics within the stacked array of filter brick 202.

By way of illustration, FIG. 2 includes dashed line 280 generally indicative of a circular area projected onto the end view of filter brick 202. The location and size of the circular area can be determined in some examples by projecting the location and size of an input conduit, such as input conduit 104 as shown in FIG. 1, onto the relative position of a filter brick, as indicated by lines 172 directed to filter brick 118 in FIG. 1. As described with respect to FIG. 1, the flow rates and volumes arriving at the input faces of the filter segments included in this area of the filter brick can be greater than the flow rates and volumes arriving at other areas of the input side of the filter brick.

Referring again to FIG. 2, filter segments 213C, 213D, 214C, and 214D have most of their input faces included within dashed line 280. In some examples, these filter segments, indicated by reference number 230, are selected to have average flow characteristics per unit area with a value that is different from the other filter segments in filter brick 202 whose input faces fall mostly outside dashed line 280. In some examples, filter segments 211A, 211B, 211C, 211D, 211E, 211F, 212A, 212B, 212C, 212D, 212E, 212F, 213A, 213B, 213E, 213F, 214A, 214B, 214E, 214F, 215A, 215B, 215C, 215D, 215E, 215F, 216A, 216B, 216C, 216D, 216E, and 216F are selected to have an average flow characteristic per unit area that is different, for example, greater than the filter segments 213C, 213D, 214C, and 214D. By selecting filter segments having different flow characteristics, and by arranging these filter segments having the different flow characteristics based on the location and sizing of the circular area indicated by 280, a filter brick can be formed that, when enclosed in a housing such as housing 102 associated with the filter 101 as shown in FIG. 1, provides a more uniform exhaust flow within and out of the filter brick, despite the non-uniform exhaust flow arriving at the input face of the filter brick.

As described in the immediately preceding example, the filter segments 240 having a given flow characteristic are arranged so as to surround the filter segments 213C, 213D, 214C, and 214D that have a different flow characteristic. However, arrangements of the filter segments within filter brick 202 are not limited to any particular arrangement. The number of each filter segments having a given flow characteristic, and the arrangement of the filter segments having the different flow characteristics within the stacked array of filter brick 202 are not limited to any particular numbers, or to any particular arrangements. Each version of filter brick 202 can be formed based on a number of considerations. In some examples, the selection and the arrangement of the filter segments is determined by the final shape of the filter brick after processing. In some examples, the selection and the arrangement of the filter segments is determined based on a known location of the input conduit coupled to a filter housing into which the filter brick is to be installed. In some examples, the selection and the arrangement of the filter segments is determined by the configuration of a regeneration device, such as but not limited to device 103 as shown in FIG. 1, that is to be included in the filter housing into which the filter brick is to be installed.

In some examples, one or more of the filter segments included in filter brick 202 are formed using different materials with respect to different filter segments. That is, filter brick 202 can be formed so as to include one or more filter segments formed of a first material, and further including one or more filter segments formed of a second material that is different from the first material. Filter segments are not limited to being formed using any particular type of material or materials. In some examples, one or more filter segments included in filter brick 202 include cordierite. In some examples, one or more filter segments included in filter brick 202 include silicon carbide. In some examples, one or more filter segments included in filter brick 202 include mullite. In some examples, one or more filter segments included in filter brick 202 include alumina. In some examples, one or more of the filter segments included in filter brick 202 include aluminum silicate. In various examples, filter brick 202 can include filter segments all formed of a same material, but having one or more different flow characteristics.

In some examples, one or more particular filter segments are formed of a single material that is different from the single material used to form other filter segments. The different materials can be selected for the filter segments, and the filter segments using the different materials can be arranged in the stacked array of filter brick 202 in order to more uniformly distribute the thermal loading within the filter brick 202 caused by the filtering of exhaust. In some examples, the thermal loading can be determined by a temperature measurement at different points in the filter brick, for example but not limited to a given point in a cross-sectional area of the filter brick within each individual filter segment. Uniform thermal loading of the filter brick reduces the thermal stress present on the filter brick, and thus reduces the chance of mechanical damage or failure of the filter brick due to cracking or other mechanical faults developing in the filter brick.

In some examples, the selection and arrangement of the of filter segments used to construct a filter brick is determined by computer modeling. In some examples, the computer modeling tailors the arrangement of the filter segments based on given flow characteristics for available filter segments and based on a modeled exhaust flow arriving at the input face of a filter brick. The modeled exhaust flow can be based on the configuration of the filter housing into which the filter brick is to be installed, including any combinations for the configuration of the input conduit, the input header, the size and shape of the interior surface of the filter housing, the exit header, and the exit conduit. In some examples, computer modeling is used to optimize the relative uniformity of the exhaust flows through the filter brick being modeled. In some examples, the computer modeling is used to optimize the uniformity of the thermal loading during operation across the filter brick being modeled.

In some examples, each of the filter segments included in a given filter brick are manufactured with the same width, height, and length, but with various and different flow characteristics. By having a standard size for the filter segments, manufacturing costs to produce the filter segments can be reduced, while allowing flexibility and tailoring of the overall flow characteristics of a filter brick formed using the standardized filter segments having the different flow characteristics. Standardized sizing of the filter segments made having the same physical size, or having the same flow characteristics, or both, but being made of different materials also reduces manufacturing costs incurred in producing the filter segments while allowing flexibility and tailoring of the overall thermal loading characteristics of the filter brick.

As noted above, the number of rows and the number of columns of filter segments included in filter brick 202 is not limited to any particular numbers. Therefore, the overall shape and dimensions of filter brick 202 as shown in FIG. 2 can be varied depending on the number of rows, the number of columns, or both the number of rows and the number of columns of filter segments included in the filter brick 202. By way of illustration, an additional column 217 is shown as an example of a filter brick including columns 211-217 and rows A-F. In this example, because of the relative number of columns and rows of filter segments in a filter brick that includes column 217, filter brick 202 has an overall shape as viewed in FIG. 2 that is generally a rectangle. In some examples, a filter brick 202 that includes column 217 can be processed to form a filter brick having an outside surface along the length of the filter brick generally conforming to the shape as indicated by dashed line 222.

In some examples, dashed line 222 is generally rectangular in shape, with a radius at each of the corners of the rectangle. It would be understood that outside shapes for a processed filter brick, such as the cylindrical shape represented by dashed line 280, or the rectangular shape represented by dashed line 222 are not limited to being formed from a filter brick having a particular initial shape or dimension. Any filter brick whose initial cross-sectional areas are large enough to fill the dimensions of the filter brick after the filter brick is processed to form the outside shape can be used. In some examples, the initial shape and dimensions of the filter brick can be chosen in order to minimize the amount of waste in the form of filter segments or portions of filter segments that will be removed in the process of the filter brick.

The filter segments forming areas of the input face of a filter brick 202 are not limited to just two subsets of filter segments each having different flow characteristic per unit area, or to just two subsets of filter segments having one subset of filter segments formed of a first material and a second subset of filter segments formed of a second material that is different from the first material. In some examples, more than two subsets or groupings of filter segments can be used to form multiple “zones” within the filter brick 202, wherein each zone differs from any other zone within the filter brick 202 with respect to flow characteristics of the filter segments within each zone, or with respect to the material used to form the filter segments within each zone, or both. By way of illustration, a “3 zone” filter brick can be formed by including in the filter brick at least three different filter segments that each have a different flow characteristic. In one example, a group of filter segments including filter segments 213C, 214C, 215C, 213D, 214D, and 215D can have a same first flow characteristic, and thus form a first zone generally indicated by dashed line 232. Additional filter segments, 212B, 213B, 214B, 215B, 212C, 216C, 212D, 216D, 212E, 213E, 214E, 215E, and 216E, surround the first zone, and include filter segments having a flow characteristic that is different from the flow characteristic of the filter segments in the first zone. In some examples, one subset of filter segments referred to as “surrounded” by one or more other filter segments refers to the surrounded filter segments being exposed on the input face and the exit face of the surrounded filter segments, but having other sides or surfaces of the surrounded filter segments adjacent to one or more other filter segments, as opposed to these other sides or surfaces being exposed as part of the outer surface of the filter brick.

A further group of filter segments includes filter segments 211A, 212A, 213A, 214A, 215A, 216A 217A, 211B, 217B, 211C, 217C, 211D, 217D, 211E, 217E, 211F, 212F, 213F, 214F, 215F, 216F, and 217F, that form a third zone. The filter segments in this third zone have a flow characteristic that is different from the flow characteristics in both the first zone and the second zone. In some examples, the filter segments in the third zone surround the filter segments in the second zone.

It would be understood that the number of zones is not limited to any particular number of zones, and in some examples, can be any positive integer number of zones. In addition, it would be understood that a zone need not include any particular number of filter segments. In some examples, a zone can include only a single filter segment.

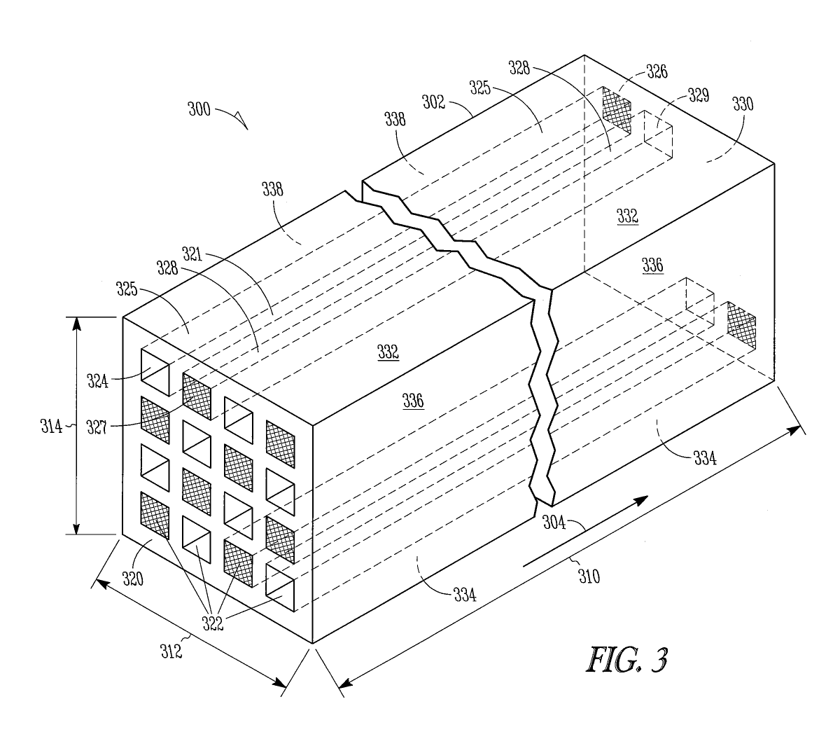

FIG. 3 illustrates a perspective view 300 of a filter segment 302. The various examples of filter segment 302 can be one or more of the filter segments 110, 120, 130, 140, 150, and 160, as shown in FIG. 1. The various examples of filter segment 302 can be one or more of the plurality of filter segments 204 as shown in FIG. 2. In some examples, filter segment 302 is a rectangular volume having an input face 320, and exit face 330, a top surface 332, a bottom surface 334, a first side surface 336, and a second side surface 338. In some examples, input face 320, exit face 330, top surface 332, bottom surface 334, first side surface 336, and second side surface 338 are each substantially a planer surface. Input face 320 is operable to receive exhaust, and to allow the exhaust to enter into filter segment 302 through one or more of the plurality of openings 322 in input face 320.

Openings in filter segment 302, including openings 322 in input face 320, are not limited to any particular shape, or to any particular dimensions. In some examples, the opening are square in shape, and have a dimension in the range of 0.5 to 3 millimeters on each side. In some examples, the openings are square in shape, and have a dimension of approximately 1.5 millimeters on each side. In various examples, openings are arranged and sized on the input face to include approximately 200 openings per square inch.

In some examples, each of openings 322 is associated with a channel running through some portion of filter segment 302. By way of illustration, opening 324 in input face 320 is associated with channel 325 running through some portion of filter segment 302, and is associated with opening 326 in exit face 330. In a further illustration, opening 327 in input face 320 is associated with channel 328 running through some portion of filter segment 302, and is associated with opening 329 in exit face 330. In some examples, the channels are rectangular shaped channels running through some portion of the length 310 of filter segment 302 from at or near input face 320 to at or near exit face 330. The filter segment 302 is not limited to any particular length 310, and in some examples length 310 ranges from 8 to 13 inches. In some examples, length 310 is approximately 12 inches.

The channels within the filter segment 302 are separated by channel walls, the channel walls formed of the material making up filter segment 302. By way of illustration, channel wall 321 separates and is adjacent to both channel 325 and channel 328. In some examples, the material used to form filter segment 302, and thus forming channel wall 321, is operable to allow exhaust gases to pass between channels while trapping particulate matter, such as soot, along and within the material of the channel wall 321. As shown in FIG. 3, each opening and associated channel can be adjacent to one or more other channels, and separated by a channel wall.

In some examples, the channels do not extent completely through the entire length 310 of filter segment 302. This is illustrated by the cross-hatching shown within some of the openings 322, and in addition, as shown by the cross-hatching shown within some openings in the exit face 330. By way of illustration, opening 324 located in the input face 320 is shown as not including cross-hatching, and opening 326 in exit face 330 is shown as including cross-hatching. Opening 324 in input face 320 is associated with channel 325, and is open at the input face 320, but channel 325 is blocked at the exit face 330, as indicated by the cross-hatching at opening 326. The opening 327 is blocked at the input face 320, but the associated channel 328 is open at the exit face 330, as indicated by opening 329. This alternation of the blocking pattern of adjacent channels is sometimes referred to as a “honeycomb” filter. In some examples, one or more of the plurality of filter segments is an extruded ceramic honeycomb.

By way of illustration, when exhaust including particulate matter reaches input face 320 of filter segment 302, the exhaust can enter into channel 325 through opening 324. However, since opening 326 associated with channel 325 is blocked, the exhaust cannot exit from channel 325 through opening 326. Instead, the exhaust passes through one or more of the channel walls, for example channel wall 321, and enters another channel, for example channel 328. In passing through channel walls, some or substantially all of the particulate matter is filtered out of the exhaust. Because the opening 329 in the exit face 330 of channel 328 is open (not blocked), the filtered exhaust is able to exit the filter segment 302 through opening 329. The direction of the flow of exhaust through filter segment 302 is generally indicated by the direction of arrow 304.

It would be understood that exhaust entering any of the openings 322 that are not blocked at input face 320 could be filtered through any channel walls adjacent to the channel associated with the opening through which the exhaust entered, and then exit out of the filter segment through any of the openings in the exit face 330 that are associated with the adjacent channels and that are not blocked.

In some examples, filter segment 302 is originally formed by an extrusion process, then processed to a length 310, wherein the extrusion process forms the channels within the filter segments through the length of the filter segments. After forming the extruded filter segment with channels completely through the filter segment, one or more of the openings in the input face of the filter segment, and one or more of the openings in the exit face of the filter segment are blocked or “plugged” so that a given channel is open at one face of the filter segment, and blocked at the opposite face of the channel. In some examples, the choice of the opening to be blocked is arranged in order to make the channel wall separating the channels operate as filters for exhaust entering the filter segment. The depth of the plug extending from the opening in the face into the associated channel is not limited to any particular depth, and in some examples has a depth in the range of 4 to 11 millimeters.

In some examples, the filter segment is formed as a solid mass without any channels. After forming a solid filter segments, opening and associated channels are provided by drilling or otherwise removing material starting at the input face, but not forming the channel completely through to the exit face. Additional channels are formed by drilling or otherwise removing material starting at the exit face, but not forming the channel completely through the entire length of the filter segment. The thus formed channels provide occluded openings having channel walls separating the occluded openings.

In some examples, input face 320 has a width 312 and a height 314. Width 312 and height 314 are not limited to any particular width and height. Width 312 and height 314 are not limited to having a same dimensional value, and in some examples the width 312 has a different dimensional value from height 314. In some examples, width 312 and height 314 have a range between 25 and 150 millimeters. In some examples, width 312 and height 314 are both approximately 34 millimeters. In some examples, width 312 and height 314 are both approximately 100 millimeters.

In various examples, filter segment 302 is comprised of a material that has a porosity that allows exhaust to pass through the material, while trapping some, or substantially all, of the particulate matter carried as part of the exhaust that arrives at input face 320.

In various examples, each of top surface 332, bottom surface 334, first side surface 336, and second side surface 338 are operable to be mechanically coupled to a top or side surface of another filter segment in order to assemble filter segment 302 into a stacked array of a filter brick, the filter brick including a plurality of filter segments. Coupling filter segments is not limited to any particular method or process. In some examples, a cement is applied to surfaces of filter segments that are to be adjacent to and mechanically coupled with surfaces of other filter segments. After the cement is applied, these surfaces of the filter segments are brought into contact with each other.

In some examples, the filter segments are assembled into the desired stacked array, and then are exposed to a heating process that calcifies the filter segments together to form a filter brick. The thickness of the cement, when used, between the adjacent filter segments in a stacked array is not limited to any particular thickness, and in some examples is in a range between 1 and 4 millimeters thick.

The flow characteristics for any given filter segment can be adjusted by varying one or more physical characteristics of the filter segment. In some examples, the selection of a particular material used to form the filter segments is configured to vary the flow characteristics of the filter segment. For example, a filter segment formed of a first material can have a first flow characteristic, and filter segments having the same physical shape and dimension but formed of a second and different material can have a second and different flow characteristic relative to the filter segment formed of the first material. The difference in the flow characteristics can be caused by the different ability of the material to allow the flow of exhaust through the materials.

In one example, a filter brick includes a number of filter segments, each of which is made of a common material and a uniform size but having a particular characteristic that varies with the different individual filter segments. For example, the filter brick can include a number of filter segments all of which are made of and same material, and wherein a first subset of the filter segments have a first porosity, and a second subset of the filter segments have a different porosity. Porosity relates to the void spaces within a material, and can be specified as a percentage between 0 and 100 percent. For a given material, porosity can be a function of open pore volume. The porosity of a filter segments can be a function of one or more characteristics of a material from which the filter segments is formed, including the raw material or material, from which the filter segment is made, the composition of the material itself, the processing of the materials or materials, including the manufacturing process or processes used to form the material. In some examples, a filter brick includes filter segments having cell density that varies between 9 and 21 micrometers, thus providing a corresponding difference in material porosity.

In another example, physical dimensions of the filter segments can be varied in order to provide different flow characteristics for filter segments. For example, the dimensions for or the size of the openings, or both, can be varied to provide different flow characteristics. In another example, the dimensions for or the size of the channels, or both, can be varied to provide different flow characteristics. Any one or a combination of these variations in the dimensions for and sizes of the openings and the channels can be varied from one filter segment to another filter segment in order to provide variation in a flow characteristics from one filter segment to another. It would be understood that the different variations of these filter segments can be included in a single filter brick in order to provide two or more subsets of filter segments within the single filter brick that have different flow characteristics from one subset of filter segments to the next subset of filter segments.

In another example, different plugging arrangements can be configured on a filter segment in order to provide more or less flow capacity, and thus different flow characteristics between one filter segment and another filter segment. In another example, the thickness of the channel walls between channels within a filter segment can be varied in order to provide filter segments with different flow characteristics.

In some examples, the space between filter segments as they are assembled into the stacked array can be varied, for example by using different thicknesses of cement or filler between the filter segments, in order to vary the density of the filter segments, and thus filter segment openings, over the surface of the input face of the filter brick. This variation in opening densities can result in different flow characteristics for different portions of the filter brick relative, for example, to some given cross-sectional area of the filter brick.

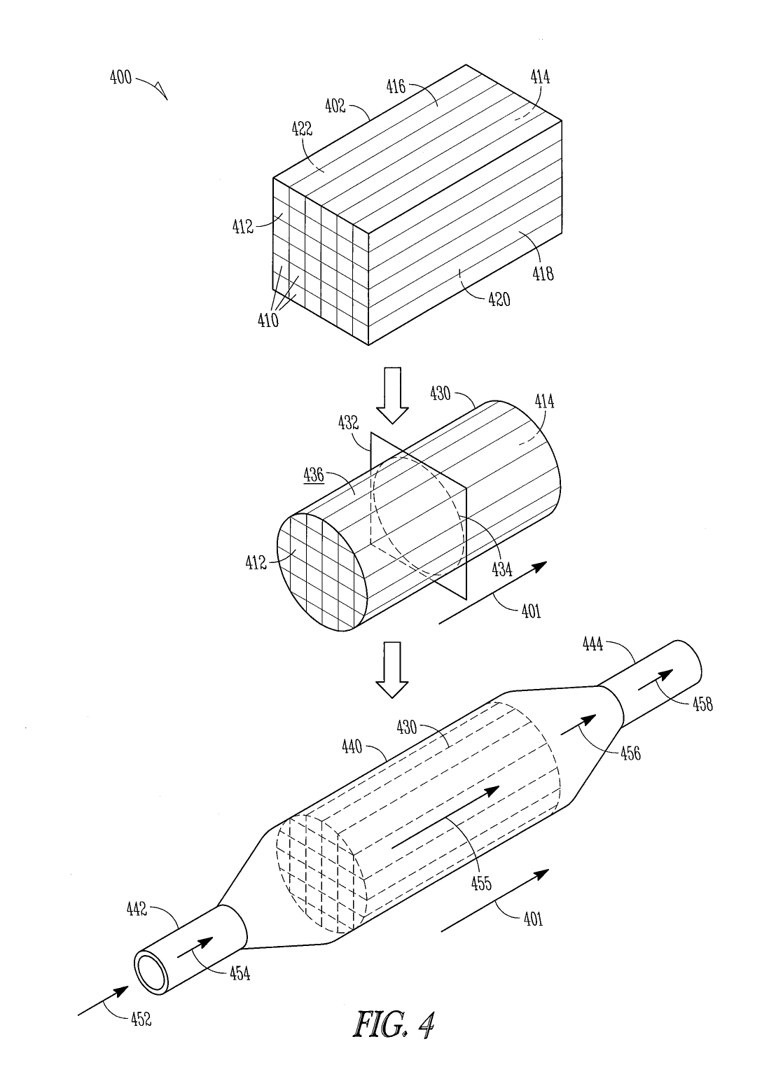

FIG. 4 illustrates a process 400 for forming a particulate filter. Process 400 includes but is not limited to any combination of the apparatus and systems, and any combination of the one or more methods, as described herein. Process 400 as shown in FIG. 4 includes forming a filter brick 402 including a plurality of filter segments 410 coupled together in a stacked array. The filter segments included in filter brick 402 can include any combination of types of filter segments arranged in the stacked array. In some examples, at least one filter segment 410 has a first flow characteristic, and at least a different one of the filter segments 410 has a second flow characteristic that is different from the first flow characteristic.

The different flow characteristics can be achieved by any of the methods described herein, including using filter segments formed using different material from one and other, filter segments having different porosities from one and other, and filter segments having different arrangements of channels and openings in the input and exit faces, different dimensions or sizes, or both different dimensions and different sizes, for either or both the openings and the channels. The different flow characteristics can be achieved by any combination of variations of these characteristics of the filter segments.

In some examples, the flow characteristics of the different filter segments used to form filter brick 402 can be exactly the same for all of the plurality of filter segments 410, but having at least one filter segment formed of a different material than at least one other filter segment within filter brick 402. The filter brick formed from filter segments of different material but having the same flow characteristics can be arranged in the stacked array to improve or to optimize the mechanical strength and thermal properties of the filter brick.

In some examples, forming the filter brick includes cementing, calcifying, or performing some other process in order to physically couple the plurality of filter segments 410 to form filter brick 402.

In various examples, the choice of filter segments, and the arrangement of the chosen filter segments used to form filter brick 402 is determined in order to improve or to optimize a particular characteristic of the filter into which the filter brick in intended to be installed. Such characteristics include but are not limited to a uniform exhaust flow through the filter brick, a uniform thermal loading of the filter brick, or both, in view of the final configuration of the filter brick after the filter brick is installed in a filter housing.

In some examples, filter brick 402 is formed with a plurality of facets in the shape of flat surfaces. As shown by way of illustration in FIG. 4, filter brick 402 includes a substantially rectangular volumetric shape having an input face 412, an exit face 414, a top surface 416, a first side surface 418, a second side surface 422, and a bottom surface 420. In some examples, filter brick 402 is generally a rectangular prism. In some examples, the input face 412, or the exit face 414, or both, lie in planes that are slanted, or not perpendicular, to one or more of the top surface 416, the first side surface 418, the second side surface 422, and bottom surface 420.

As shown in FIG. 4, filter brick 402, after being formed, can be further processed to form filter brick 430. Filter brick 430 can be formed by processing one or more of the surfaces of filter brick 402 to form a filter brick with input face 412, exit face 414, and with one or more outer surfaces 436. As illustrated in FIG. 4, outer surfaces 436 are generally cylindrical, having a cross-sectional shape 434 along plane 432, wherein the axis of the cylinder extends between input face 412 and exit face 414 in an orientation corresponding to the flow arrow 401.

The shape of outer surface 436 is not limited to any particular shape, and can include oval, elliptical, or generally square or generally rectangular shapes in cross-section along the length of the outer surface 436 along flow arrow 401. In some examples that include generally square or generally rectangular shapes, the area where two facets of outer surface 436 meet may have a radius formed connecting the facets in a generally rounded curve shape. In some examples, the cross-sectional shape of the filter brick 430 in plane 432 is “L” shaped. The outer surface 436 is not limited to having the same cross-sectional shape or dimension along the entire length of outer surface. In some examples, the cross-sectional dimension of filter brick 430 is different at different points along the length of filter brick 430.

Generally, the outer surface 436 is processed in order to conform filter brick 430 to a shape that can be enclosed within a filter housing so that the filter brick, in conjunction with any sheathing that is provided in contact with the outer surface 436, will substantially fill some cross-sectional portion of the filter housing. Any suitable process for shaping filter brick 402 so as to have the outer surface 436 can be used to form filter brick 430, including but not limited to grinding, water jet cutting, or laser cutting. In some examples, after initial processing for shaping, outer surface 436 can be sealed with a filler or a cement material (not shown in FIG. 4). In examples where the filler or cement is used, the filler or cement is applied to the outside of filter brick 430 to a thickness. In some examples, the thickness is in a range of 1 to 3 millimeters. In some examples, the filler or cement can fill any openings in outer surface 436 that are created by the processing that exposed a channel within filter brick 430 to the outer surface 436. In some examples, further processing is performed on the filler or cement after the filler or cement is applied to outer surface 436 to form the shape and the dimensions of outer surface 436.

In some examples, process 400 as illustrated in FIG. 4, includes enclosing filter brick 430 in a filter housing 440 to form a particulate filter. In some examples, filter housing 440 is coupled to an input conduit 442, and to an exit conduit 444. In some examples, filter brick 430 is enclosed within filter housing 440 so that exhaust entering the filter housing 440 through input conduit 442 passes through filter brick 430 before exiting filter housing 440 through exit conduit 444.

In some examples, outer surface 436 has a shape and has cross-sectional dimensions along the length of filter brick 430 that are designed to allow outer surface 436 to contact an inner wall of filter housing 440 along substantially most of the outer surface 436. In some examples, outer surface 436 is covered with a sheath (not shown in FIG. 4), the sheath forming a layer between the outer surface 436 and the inner wall of filter housing 440.

In operation, exhaust as represented by arrow 452 enters housing 440 through input conduit 442, as represented by arrow 454. Exhaust then flows through filter brick 430, as represented by arrow 455. In the process of flowing through filter brick 430, particulate matter is trapped in filter brick 430, providing filtered exhaust. The filtered exhaust exits filter brick 430, as represented by arrow 456. The filtered exhaust then exits housing 440 through exit conduit 444, as represented by arrow 458.

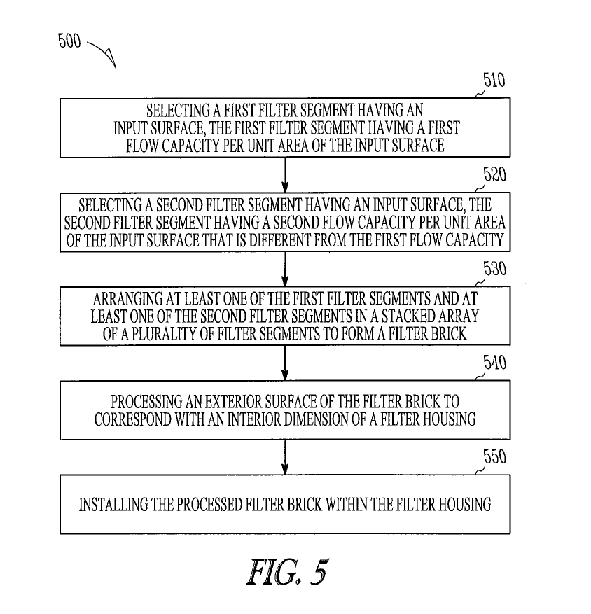

FIG. 5 illustrates a flowchart of a method 500.

At 510, method 500 includes selecting a first filter segment, the first filter segment having a first flow capacity per unit area of the input surface. In various examples, the first filter segment includes having an input surface operable to receive exhaust, and an exit surface operable to allow filtered exhaust to exit the first filter segment.

At 520, method 500 includes selecting a second filter segment, the second filter segment having a second flow capacity per unit area of the input surface that is different from the first flow capacity. In various examples, the second filter segment includes having an input surface operable to receive exhaust and an exit surface operable to allow filtered exhaust to exit the second filter segment.

In various examples, selecting the first filter segment includes selecting a filter segment formed from a material having a first porosity, and selecting the second filter segment includes selecting a filter segment formed from the material and having a second porosity that is different from the first porosity.

In various examples, selecting the first filter segment includes selecting a filter segment formed of a first material, and selecting the second filter segment includes selecting a filter segment formed of a second material that is different from the first material.

In various examples, selecting the first filter segment includes selecting a filter segment having one or more cell openings in the input surface of the first filter segment, the input surface of the first segment having a first area; and wherein selecting the second filter segment includes selecting a filter segment having one or more cell openings in the input surface of the second filter segment, the input surface of the second filter segment having a second area that is different from the first area.

At 530, method 500 includes arranging at least one of the first filter segments and at least one of the second filter segments in a stacked array of a plurality of filter segments to form a filter brick. In some examples, arranging includes arranging the filter segments to form a filter brick having input surfaces on a first side of the filter brick and exit surfaces on a second side of the filter brick.

In various examples, arranging at least one of the first filter segments and at least one of the second filter segments includes arranging a plurality of the second filter segments to surround a plurality of the first filter segments.

At 540, method 500 includes processing an exterior surface of the filter brick to correspond with an interior dimension of a filter housing.

At 550, method 500 includes installing the processed filter brick within the filter housing. In various examples, installing the processed filter brick within the filter housing includes installing a sheath as a layer between an outer surface of the filter brick and an interior surface of the filter housing.

### INDUSTRIAL APPLICABILITY

A diesel particulate filter is often used to perform a filtering operation as part of an exhaust system for a diesel engine. The diesel particulate filter provides filtering of particulate matter from the exhaust in order to meet various emission standards that are applicable to the operation of the diesel engine. In addition, in certain environments, such as underground mining, the filtering process performed by the diesel particulate filter can be critical to the health and safety of personnel working in these environments. Improvements, including optimization of one or more properties of the diesel particulate filter, are beneficial in providing a durable and properly operating filter in a physically compact size device. The one or more properties of concern include, but are not limited to, providing a uniform distribution of thermal loading within the diesel particulate filter as the filter is being operated, and optimization of the physical strength characteristics of the diesel particulate filter.

The above description is intended to be illustrative, and not restrictive. For example, the above-described examples (or one or more aspects thereof) may be used in combination with each other. Other examples can be used, such as by one of ordinary skill in the art, upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims.

What is claimed is:

1. A particulate filter comprising:
a housing having a flow axis between an input header and an output header; and
a plurality of filter segments arranged in a stacked array, the stacked array disposed within the housing and lying in a plane normal to the flow axis, the stacked array including a first filter segment having a first average flow characteristic per unit area and a second filter segment having a second average flow characteristic per unit area, the first average flow characteristic per unit area different from the second average flow characteristic per unit area, each particular filter segment of the plurality of filter segments having a segment flow axis substantially in parallel alignment with the flow axis.

2. The filter of claim 1, wherein the first filter segment includes a first material having a first porosity, and the second filter segment includes a second material having a second porosity that is different from the first porosity.

3. The filter of claim 1, wherein at least one of the plurality of filter segments includes an extruded ceramic honeycomb.

4. The filter of claim 1, wherein an input surface of the first filter segment is approximately coplanar with an input surface of the second filter segment.

5. The filter of claim 1, wherein a length of the first filter segment is approximately equal to a length of the second filter segment.

6. The filter of claim 1, wherein the stacked array includes a core having one or more first filter segments coupled together, the core surrounded by a plurality of the second filter segments.

7. The filter of claim 6, wherein the core is substantially exposed only at an input surface of the stacked array and at an exit surface of the stacked array.

8. The filter of claim 1, wherein the stacked array is arranged to include:
a first subset of the plurality of filter segments including the first filter segment, each of the filter segments in the first subset having the first average flow characteristic per unit area; and
a second subset of the plurality of filter segments including the second filter segment, each of the filter segments in the second subset having the second average flow characteristic per unit area, and arranged so as to surround the first subset.

9. The filter of claim 8, further including:
a third subset of the plurality of filter segments, the third subset of filter segments surrounding the second subset of filter segments, each of the filter segments in the third subset having a third average flow characteristic per unit area that is different from the first average flow characteristic and the second average flow characteristic.

10. A particulate filter comprising:
a housing having a flow axis between an input header and an output header; and
a plurality of filter segments arranged in a stacked array, the stacked array disposed within the housing and lying in a plane normal to the flow axis, including a first filter segment formed of a first material, and a second filter segment formed of a second material that is different from the first material, each particular filter segment of the plurality of filter segments having a segment flow axis substantially in parallel alignment with the flow axis and having a distribution of channels within the particular filter segment.

11. The filter of claim 10, wherein each of the plurality of filter segments includes an input surface, and wherein the input surfaces are coplanar with the plane normal to the flow axis.

12. The filter of claim 10, wherein each filter segment of the plurality of filter segments has a same length, and each filter segment of the plurality of filter segments has an exit surface coplanar with the plane normal to the flow axis.

13. The filter of claim 10, wherein the stacked array includes a core having one or more first filter segments coupled together and each formed of the first material, the core surrounded by a plurality of second filter segments, each of the second filter segments formed of the second material.

14. A method of forming a filter comprising:
selecting a first filter segment having an input surface operable to receive exhaust and an exit surface operable to allow filtered exhaust to exit the first filter segment, the first filter segment having a first flow capacity per unit area of the input surface;
selecting a second filter segment having an input surface operable to receive exhaust and an exit surface operable to allow filtered exhaust to exit the second filter segment, the second filter segment having a second flow capacity per unit area of the input surface that is different from the first flow capacity; and
arranging at least one of the first filter segments and at least one of the second filter segments in a stacked array of a plurality of filter segments to form a filter brick having input surfaces on a first side of the filter brick and exit surfaces on a second side of the filter brick.

15. The method of claim 14, wherein selecting the first filter segment includes selecting a filter segment formed from a material having a first porosity, and selecting the second filter segment includes selecting a filter segment formed from the material and having a second porosity that is different from the first porosity.

16. The method of claim 14, wherein selecting the first filter segment includes selecting a filter segment formed of a first material, and selecting the second filter segment includes selecting a filter segment formed of a second material that is different from the first material.

17. The method of claim 14, wherein selecting the first filter segment includes selecting a filter segment having one or more openings in the input surface of the first filter segment, the input surface of the first segment having a first area; and
wherein selecting the second filter segment includes selecting a filter segment having one or more openings in the input surface of the second filter segment, the input surface of the second filter segment having a second area that is different from the first area.

18. The method of claim 14, wherein arranging at least one of the first filter segments and at least one of the second filter segments includes arranging a plurality of the second filter segments to surround a plurality of the first filter segments.

19. The method of claim 14, further including processing an exterior surface of the filter brick to correspond with an interior dimension of a filter housing.

20. The method of claim 19, further including installing the processed filter brick within the filter housing.
